(19) United States
(12) Patent Application Publication
(10) Pub. No.: US 2003/0120845 A1
(43) Pub. Date: Jun. 26, 2003

(54) Network device for sound and vision transmission

(76) Inventor: Hsien-Chung Chou, Taipei (TW)

Correspondence Address: Finnegan, Henderson, Farabow,, Garrett & Dunner, L.L.P., 1300 I Street, N.W., Washington, DC, 20005-3315, US

(21) Appl. No.: 10/167,398

(22) Filed: Jun. 13, 2002

(30) Foreign Application Priority Data
Dec. 20, 2001 (TW) 90220032

(51) Int. Cl. G06F 13/12

(52) U.S. Cl. 710/72

(57) ABSTRACT

A network device for sound and vision transmission is proposed, and linked up to Internet for allowing a user to freely process sound and vision communication. The network device includes an analysis processing module and an input/output controlling module connected to the analysis processing module, in which large area broadband wireless internet access service or wired broadband internet access service is adopted for establishing network connection between the network device and Internet, so as to achieve synchronization in sound and vision transmission, and to shorten communication distance between users. The input/output controlling module is also associated with connection interfaces for combining the network device with peripheral devices that provides additional functions as desired by the users. Alternatively, the network device can also selectively function for sound or vision transmission only, without being limited to synchronic sound and vision transmission.

### FIELD OF THE INVENTION

The present invention relates to network devices for sound and vision transmission, and more particularly, to a network device for sound and vision transmission, which is connected to Internet by using large area broadband wireless net access service or wired broadband net access service, allowing a user to process synchronization of sound and vision transmission.

### BACKGROUND OF THE INVENTION

With development in electronic, communication, computer and other related technologies, evolutions for example, from desktop computers to notebook computers, from local networks to Internet, from wired networks to wireless networks, and from personal digital assistants (PDA or Palm) to packet personal computers (packet PC), are all directed toward providing users with intelligent portable electronic devices that are more convenient in use and have stronger functions.

Commercially-available intelligent portable electronic devices are endowed with dedicated characteristics. For example, personal digital assistants are originally designed for use in personal information management such as recording personal address books, agenda, memoranda, etc. As Internet is getting widely used, personal digital assistants are now provided with additional network-lining and communication functions. Besides, in response to efficient growth of network, communication and information appliance (IA), personal digital assistants are increasingly demanded in the market. For this reason, packet personal computers with similar functions to desktop computers are readily available, which functions include for example, providing simplified editions of application software such as Word, Excel, Outlook, etc; internally building up a media player by WinCE to listen to MP3 music; and using a modem for network connection. Moreover, current cellular phones (GSM system) can even function in retrieving immediate simple messages from websites, which websites are particularly designed in wireless markup language (WML) format for use in wireless application protocol (WAP).

In response to incoming third generation (3G) of mobile communication, besides data retrieval and storage through websites (e.g. net browsing, data downloading, email processing, etc), intelligent portable electronic devices are developing toward capable of proceeding sound and vision transmission, for example, conducting conversations and vision transmission through networks, without limiting web page format in transmission to conventional WAP format. Therefore, how to provide users with a network device for sound and vision transmission is a present issue that needs to be solved.

Furthermore, it is also desired to provide users with a network device for sound and vision transmission that can independently operate without using a desktop computer, notebook computer or packet personal computer. The network device for sound and vision transmission can further be freely set up anywhere preferred by users for use in sound and vision transmission, without being limitedly located around a wired network as for a desktop computer. This therefore provides a new style of communication, and allows users to perform sound and vision transmission through direct connection between ISP wires and RJ45 in place of conventional computer wired connection.

### SUMMARY OF THE INVENTION

A primary objective of present invention is to provide a network device for sound and vision transmission, allowing users to transmit sounds and visions anywhere and anytime.

Another objective of the invention is to provide a network device for sound and vision transmission, which provides multiple functions for diversified application.

In accordance with the above and other objectives, the present invention proposes a network device for sound and vision transmission, for use in an intelligent electronic device, whereby the intelligent electronic device is connected to Internet for allowing a user to proceed network sound and vision transmission, which intelligent electronic device includes a keyboard, a camera, a monitor, an earphone and a microphone. The network device comprising: an analysis processing module, including a central processing unit, and a main memory for storing programs and data required in operation of the network device and for allowing the central processing unit to retrieve and execute the programs stored in the main memory; and an input/output controlling module, including a network transmission module, a vision processing module and a sound processing module; wherein the network transmission module links up the network device to Internet, for allowing a user to perform sound and vision transmission; wherein after the network device is liked to Internet and the central processing unit determines that the user initiates network communication with the other party, the central processing unit retrieves and executes a vision shooting program stored in the main memory, and prompts the camera to process shooting, whereby a shot vision is transmitted to the vision processing module for vision processing, and then the processed vision is delivered through the network transmission module to the other party, so as to allow the other party to receive the instantly shot vision; or the network transmission module transmits a vision from the other party to the vision processing module for vision processing, and then transmits the processed vision to the user, so as to allow the user to instantly receive the vision through the monitor from the other party; wherein after the network device is linked to Internet and the central processing unit determines that the user initiates network communication with the other party, the central processing unit retrieves and executes a sound processing program stored in the main memory, and prompts the sound processing module to process a sound received by the microphone from the user, whereby the processed sound is transmitted by the network transmission module to the other party, so as to allow the other party to instantly receive the sound from the user; or the network transmission module transmits a sound from the other party to the sound processing module for sound processing, and then transmits the processed sound to the user, so as to allow the user to instantly receive the sound through the earphone from the other party.

The network device for sound and vision transmission further comprises an incoming call notifying module. When the network transmission module of the input/output controlling module receives a calling request from the other party, the incoming call notifying module generates an incoming call notification to notify the user that the network device is receiving a call from the other party, wherein the incoming call notification includes a ring, music or sound produced from an amplifier, a flash generated by a light source, or vibration of the network device.

The input/output controlling module is provided with a plurality of connection interfaces for combining the network devices of the invention with peripheral devices, which connection interfaces include, for example, USB, IEEE1394, RS232, IDE, PS/2 etc, and the peripheral devices include a memory medium, printer, scanner and so on. The network device of the invention therefore allows the user to freely process wireless sound and vision network transmission, and also to log in Internet by directly plugging a RJ-45 connection port into an existing fixed wired network.

By using the network device for sound and vision transmission of the invention, the user is allowed to process sound and vision transmission through Internet anywhere and anytime without necessarily using a computer device. Besides, the user can combine various types of peripheral devices with the network device of the invention; therefore, the invention indeed provides a convenient and multifunctional network device for sound and vision transmission.

### BRIEF DESCRIPTION OF THE DRAWING

The present invention can be more fully understood by reading the following detailed description of the preferred embodiments, with reference made to the accompanying drawing wherein:

FIG. 1 is a schematic block diagram showing systematic architecture of a preferred embodiment of a network device for sound and vision transmission of the invention.

### DETAILED DESCRIPTION OF THE PREFERRED EMBODIMENTS

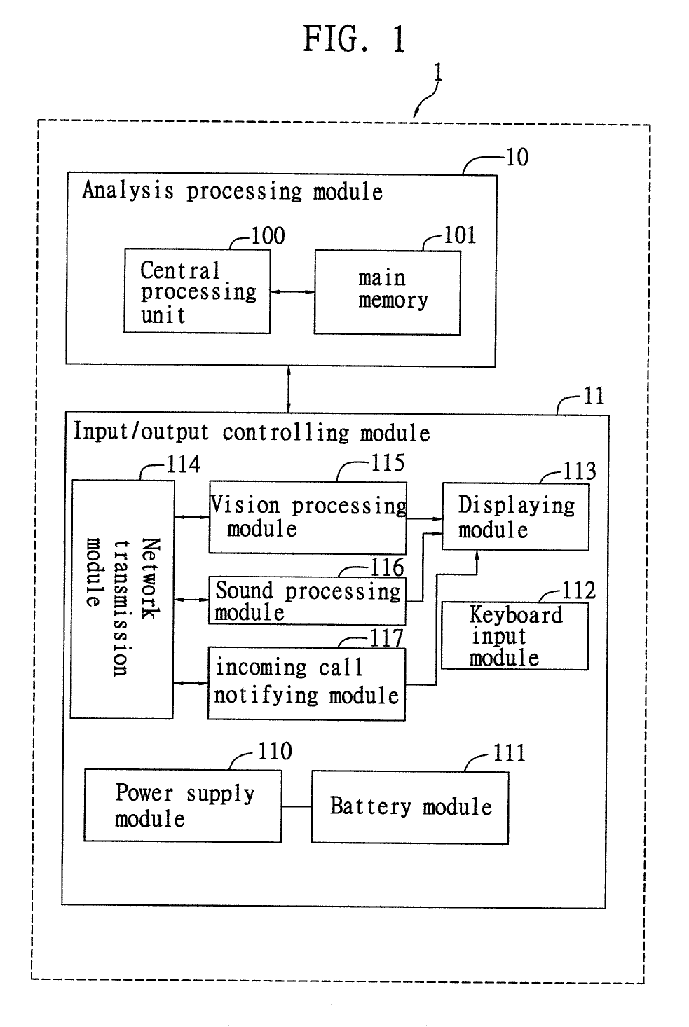

Illustrated in FIG. 1 is a schematic block diagram showing systematic architecture of a preferred embodiment of a network device for sound and vision transmission of the present invention. As shown in the drawing, the network device for sound and vision transmission 1 of the invention can be a portable or fixed device, and also can be made in the form of a common intelligent electronic device, such as notebook computer, personal digital assistant (PDA), packet personal computer (packet PC), etc (all are not shown). The network device for sound and vision transmission 1 mainly comprises an analysis processing module 10 and an input/output controlling module 11.

The analysis processing module 10 is a core component of the network device for sound and vision transmission 1, and comprises a central processing unit 100, a main memory 101 and others. The main memory 101 includes, for example, a read only memory (ROM) and a random access memory (RAM), for allowing the central processing unit 100 to retrieve, store and execute programs directly through the main memory 101. In other words, all programs and data needed in operation of the network device for sound and vision transmission 1 of the invention, such as system and function programs, can be stored in ROM and RAM of the main memory 101 by the central processing unit 100. Since the central processing unit 100 and main memory 101 are well known electronic components in the art, no further description for functions and internal structures thereof is to be detailed hereinafter.

The input/output controlling module 11 is coupled to the analysis processing module 10, and communicates between a user and the network device for sound and vision transmission 1. The input/output controlling module 11 comprises a power supply module 110, a battery module 111, a keyboard input module 112, a displaying module 113, a network transmission module 114, a vision processing module 115, a sound processing module 116 and an incoming call notifying module 117. It should be understood that, the network device for sound and vision transmission 1 also comprises other components, such as I/O controlling chips, encoding/decoding electronic components etc, which are not shown in the drawing; for the sake of simplicity, only associated components relating to the invention are illustrated herein.

The power supply module 110 is externally connected to a power supplier (not shown), which power supplier includes an adapter for converting alternating current into direct current and supplies power to the network device for sound and vision transmission 1. The power supply module 110 is internally connected to the battery module 111 provided with a plurality of batteries (not shown), which are charged by power from the power supply module 110, allowing a user to use the network device for sound and vision transmission 1 outdoors. Further, a battery protecting module (not shown) is interposed between the power supply module 110 and the battery module 111, for stopping battery charging when the batteries of the battery module 111 are fully charged.

The keyboard input module 112 allows the user to input commands thereto for operating the network device for sound and vision transmission 1; the displaying module 113 is used to display operational status of the network device for sound and vision transmission 1. Since the keyboard input module 112 and displaying module 113 are basic components in general electronic devices, they are not further to be detailed herein for function and internal structures thereof The network transmission module 114 links up the network device for sound and vision transmission 1 to Internet via a network, allowing the user to retrieve information from websites through Internet. The network transmission module 114 can be externally connected to a wireless network card (not shown) that is wirelessly linked to Internet, in which the network transmission module 114 provides a wireless transmission interface, through the use of large area broadband wireless net access service, allowing wireless transmission service to be offered to point-to-point communication, high buildings and complexes. This can be achieved only by using currently available communication systems provided by ISP, with transmission speed reaching up to 4.5 to 32 Mbps, thereby making the user not necessary to conduct format conversion while retrieving web information via the network device for sound and vision transmission 1. Alternatively, the network transmission module 114 can be externally coupled to a common wired network card (not shown), which is connected to a network, for example, by using a RJ-45 connection port, to be further linked up to a host (not shown) associated with Internet, so as to retrieve information provided by websites and display the retrieved information in the displaying module 113.

After being wiredly or wirelessly connected to Internet through the network transmission module 114, the network device for sound and vision transmission 1 of the invention allows the user to download and browse website information, and also to freely process sound and vision transmission, wherein the vision processing module 115 is connected to a camera and a monitor (both not shown). After the network transmission module 114 is linked up to a network, and the central processing unit 100 determines the user establishes network communication with the other party (since procedures, such as logging in a server, inputting the other party's telephone number and so on, compulsorily performed prior to network communication are well known in the art, no further description thereof is to be detailed herein), the central processing unit 100 retrieves and executes a vision shooting program (not shown) stored in the main memory 101, so as to prompt the camera to proceed shooting, and transmit a shot vision signal to the vision processing module 115 for signal processing. The processed vision signal is sent out by the network transmission module 114, allowing the other party to instantly receive the shot vision. On the other hand, the network transmission module 114 can receive a vision signal from the other party and transmit it to the vision processing module 115 for vision signal processing, so that the user can immediately obtain the vision from the other party through the displaying module 113. Nevertheless, in the case of using the network device for sound and vision transmission 1 only for sound transmission, installation of the camera and monitor in the vision processing module 115 is not necessary.

The sound processing module 116 is connected to a common earphone and microphone or to an earphone and microphone of bluetooth communication interface. Similarly as described above, after the network transmission module 114 is linked up to a network, and the central processing unit 100 determines the user establishes network communication with the other party, the central processing unit 100 retrieves and executes a sound processing program stored in the main memory 101, so as to prompt the sound processing module 116 to receive a sound from the user through the microphone, and transmit a processed sound signal through the network transmission module 114 to the other party, allowing the other party to instantly hear the sound from the user. On the other hand, the network transmission module 114 can receive a sound from the other party, and transmits it to the sound processing module 116 for sound signal processing, so that the user can immediately hear the sound from the other party through the earphone.

Besides, the network device for sound and vision transmission 1 is further provided with the incoming call notifying module 117 that is connected to an amplifier (not shown). When the network transmission module 114 of the input/output controlling module 11 receives a calling request from the other party, the central processing unit 100 retrieves and executes an incoming call notifying program (not shown) stored in the main memory 101, so as to prompt the incoming call notifying module 117 to generate an incoming call notification, for notifying the user that the device of network sound and vision 1 is receiving a call from the other party. This incoming call notification generated by the incoming call notifying module 117 is conducted in a manner including, for example, generating a ring, music or sound by the amplifier, or producing a flash by a light source (such as initiating LED for flashing), or initiating vibrations of the network device 1; since these methods of notification are commonly used, they are not to be further described herein.

Therefore, after being linked up to Internet (not shown) through the network transmission module 114, by using the vision processing module 115 and the sound processing module 116, the user is allowed to see and hear the other party during network communication, and such vision and sound synchronization can truly shorten the communication distance between different users.

In addition, the input/output controlling module 11 of the network device for sound and vision 1 can also be additionally provided with several connection interfaces (not shown), for example, USB, IEEE1394, RS232, IDE, PS/2 etc, which interfaces are used to be connected to peripheral devices. This allows the user to be optionally connected to the interfaces that are associated with desired peripheral devices. During operation of any of the peripheral devices, a signal from the peripheral device is transmitted to the analysis processing module 10 by the input/output controlling module 11, making the network device for sound and vision transmission 1 respond correspondingly according to the transmitted signal. For example, the input/output controlling module 11 provided with a connection interface (not shown) is externally connected to an earphone and microphone (both not shown) of bluetooth standard communication, in cooperation with the vision processing module 115 and sound processing module 116; this then provides the user with no limitation and long distance communication. Further, a connection interface (not shown) is provided for being externally connected to a data storage medium (not shown), such as a CF (compact flash) card or MMC (multimedia) card and so on, allowing the user of the network device 1 to download website information into the data storage medium for storage, or to store inputted or edited data through the keyboard input module 112 into the data storage medium, which inputted or edited data include those when initiating and processing a personal address book, agendum, memorandum and other functions provided by the network device 1 (these functions can be stored in the main memory 101 of the analysis processing module 10 in advance). Another connection interface (not shown) is used to be externally connected to a receiver (not shown) of a global position system (GPS), which receiver is capable of receiving a signal generated from a satellite navigating system and thus indicating the present location of the network device 1, so that a neighborhood map and moving positions of the network device 1 can be displayed through the displaying module 113.

Therefore, by virtue of being connected to a network system, e.g. global position system, Internet, local network etc, the network device for sound and vision transmission 1 of the invention can act as an initiating device of the network system, and allow users to proceed vision and sound network communication, long distance conference, product promotion, on line shopping, and other network information communication.

Accordingly, the network device for sound and vision transmission 1 of the invention is capable of extending connection interfaces provided by the input/output controlling module 11 in response to users' requirements. Thus, the invention is advantageous in provision of a multi-functional network device for sound and vision transmission with flexibility in function integration as desired by the users.

The invention has been described using exemplary preferred embodiments. However, it is to be understood that the scope of the invention is not limited to the disclosed embodiments. On the contrary, it is intended to cover various modifications and similar arrangements. For example, other peripheral devices, such as a printer, an infrared receiving/sending unit etc, can be externally connected to the input/output controlling module 11, for allowing users to print out needed information and operate remote control; besides externally connection, part or all of the peripheral devices can be internally built in the input/output controlling module 11, with no particular limitation, depending on practical needs and purposes for using the network device for sound and vision transmission of the invention. The scope of the claims, therefore, should be accorded the broadest interpretation so as to encompass all such modifications and similar arrangements.

What is claimed is:

1. A network device for sound and vision transmission, for use in an intelligent electronic device, whereby the intelligent electronic device is connected to Internet for allowing a user to proceed network sound and vision transmission, which intelligent electronic device includes a keyboard, a camera, a monitor, an earphone and a microphone; the network device comprising:
an analysis processing module, including a central processing unit, and a main memory for storing programs and data required in operation of the network device and for allowing the central processing unit to retrieve and execute the programs stored in the main memory; and
an input/output controlling module, including a network transmission module, a vision processing module and a sound processing module; wherein the network transmission module links up the network device to Internet, for allowing a user to perform sound and vision transmission; wherein after the network device is linked to Internet and the central processing unit determines that the user initiates network communication with the other party, the central processing unit retrieves and executes a vision shooting program stored in the main memory, and prompts the camera to process shooting, whereby a shot vision is transmitted to the vision processing module for vision processing, and then the processed vision is delivered through the network transmission module to the other party, so as to allow the other party to instantly receive the shot vision; or the network transmission module transmits a vision from the other party to the vision processing module for vision processing, and then transmits the processed vision to the user, so as to allow the user to instantly receive the vision through the monitor from the other party; wherein after the network device is linked to Internet and the central processing unit determines that the user initiates network communication with the other party, the central processing unit retrieves and executes a sound processing program stored in the main memory, and prompts the sound processing module to process a sound received by the microphone from the user, whereby the processed sound is transmitted by the network transmission module to the other party, so as to allow the other party to instantly receive the sound from the user; or the network transmission module transmits a sound from the other party to the sound processing module for sound processing, and then transmits the processed sound to the user, so as to allow the user to instantly receive the sound through the earphone from the other party.

2. The network device of claim 1, wherein the network device for sound and vision transmission further comprises an incoming call notifying module, when the network transmission module of the input/output controlling module receives a calling request from the other party, the incoming call notifying module generating an incoming call notification to notify the user that the network device is receiving a call from the other party.

3. The network device of claim 2, wherein the incoming call notification generated by the incoming call notifying module, includes a ring, music or sound produced from an amplifier, a flash generated by a light source, or vibration of the network device.

4. The network device of claim 1, wherein the input/output controlling module further includes a plurality of connection interfaces for combining the network device with peripheral devices.

5. The network device of claim 4, wherein the connection interfaces include a USB interface, an IEEE1394 interface, a parallel port interface, a serial port interface, an IDE interface, a PS/2 interface and an infrared port interface.

6. The network device of claim 4, wherein the peripheral devices include a memory medium, an earphone, a microphone, a global position system receiver, a printer, a scanner and an infrared receiver.

7. The network device of claim 1, wherein the earphone and the microphone associated with the sound processing module, operate sound transmission through the use of a bluetooth communication interface.

8. The network device of claim 1, wherein the network transmission module is composed of a wireless local network card and an Ethernet-supportive network transmission interface.

9. The network device of claim 8, wherein the Ethernet-supportive network transmission interface is a RJ-45 connection port.

10. The network device of claim 8, wherein the wireless local network card operates wireless transmission through the use of a communication interface provided by large area broadband wireless net access service.

11. The network device of claim 1, wherein the network transmission module is composed of a wired local network card.

12. The network device of claim 6, wherein the global position system receiver associated with the network device allows the user to learn current location of the network device.

13. The network device of claim 1, wherein the intellectual electronic device is a portable electronic device.

14. The network device of claim 13, wherein the portable electronic device is a personal digital assistant, a packet personal computer or a cellular phone.

15. The network device of claim 1, wherein the intelligent electronic device is a computer device.

16. The network device of claim 15, wherein the computer device is a desktop computer or a notebook computer.

17. The network device of claim 1, wherein the intelligent electronic device is a household telephone.

18. A network device for sound transmission, for use in an intelligent electronic device, whereby the intelligent electronic device is connected to Internet for allowing a user to proceed network sound transmission, which intelligent electronic device includes a keyboard, an earphone and a microphone; the network device comprising:
an analysis processing module, including a central processing unit, and a main memory for storing programs and data required in operation of the network device and for allowing the central processing unit to retrieve and execute the programs stored in the main memory; and
an input/output controlling module, including a network transmission module and a sound processing module; wherein the network transmission module links up the network device to Internet, for allowing a user to perform sound transmission; wherein after the network device is linked to Internet and the central processing unit determines that the user initiates network communication with the other party, the central processing unit retrieves and executes a sound processing program stored in the main memory, and prompts the sound processing module to process a sound received by the microphone from the user, whereby the processed sound is transmitted by the network transmission module to the other party, so as to allow the other party to instantly receive the sound from the user; or the network transmission module transmits a sound from the other party to the sound processing module for sound processing, and then transmits the processed sound to the user, so as to allow the user to instantly receive the sound through the earphone from the other party.

19. A network device for vision transmission, for use in an intelligent electronic device, whereby the intelligent electronic device is connected to Internet for allowing a user to proceed network vision transmission, which intelligent electronic device includes a keyboard, a camera and a monitor; the network device comprising:
an analysis processing module, including a central processing unit, and a main memory for storing programs and data required in operation of the network device and for allowing the central processing unit to retrieve and execute the programs stored in the main memory; and
an input/output controlling module, including a network transmission module and a vision processing module; wherein the network transmission module links up the network device to Internet, for allowing a user to perform sound and vision transmission; wherein after the network device is linked to Internet and the central processing unit determines that the user initiates network communication with the other party, the central processing unit retrieves and executes a vision shooting program stored in the main memory, and prompts the camera to process shooting, whereby a shot vision is transmitted to the vision processing module for vision processing, and then the processed vision is delivered through the network transmission module to the other party, so as to allow the other party to instantly receive the shot vision; or the network transmission module transmits a vision from the other party to the vision processing module for vision processing, and then transmits the processed vision to the user, so as to allow the user to instantly receive the vision through the monitor from the other party.
